(19) United States
(12) Patent Application Publication
(10) Pub. No.: US 2017/0188010 A1
(43) Pub. Date: Jun. 29, 2017

(54) RECONSTRUCTION OF LOCAL CURVATURE AND SURFACE SHAPE FOR SPECULAR OBJECTS

(71) Applicant: CANON KABUSHIKI KAISHA, Tokyo (JP)

(72) Inventors: Mahdi Nezamabadi, San Jose, CA (US); Manuel Martinello, Mountain View, CA (US)

(21) Appl. No.: 14/983,365

(22) Filed: Dec. 29, 2015

(51) Int. Cl. H04N 13/02; B29C 67/00; B33Y 50/02; H04N 5/225

(52) U.S. Cl. CPC H04N 13/0203; H04N 5/2256; B29C 67/0088; B33Y 50/02

(57) ABSTRACT

Recovery of local curvature and surface shape of an object having a specular component of reflection such as a mirror-like or specular object. The object is illuminated by a rainbow-like ordered spectrum of spatially distributed light whose wavelength varies in accordance with angle, and a spectral image is captured of the object. Local curvature is estimated for a point on the object based on spectral width at a wavelength peak of light reflected from the point, with a relatively wider width corresponding to a locally convex curvature and a relatively narrow width corresponding to a locally concave curvature. Surface shape information is recovered using the captured image based on a set relationship, obtained by calibration, by which wavelength of the ordered spectrum varies in accordance with angle. Physical and/or graphical replication of the object is informed by the recovered local curvature and surface shape.

### FIELD

The present disclosure relates to recovery of local curvature and surface shape of glossy objects such as mirror-like and specular objects, or objects having a specular component of reflection, such as for 3D replication of the object physically or representationally.

### RELATED ART

Objects fabricated from a glossy material, such as specular objects or mirror-like objects, have reflection characteristics that differ significantly from those fabricated from a diffuse material. For example, for a diffuse object, light from a directional light source such as a projector is reflected in virtually all directions, whereas for a glossy object, such light is reflected in primarily only one direction or at most only a few directions. These reflections are called “specular” reflections, and are caused by the shiny surface of the glossy material, which often has a mirror-like surface finish. As a result, an image of a glossy object illuminated by a directional light source often appears completely dark, unless the camera happens to be positioned at the precisely correct viewing direction so as to capture the specular reflection.

Moreover, for glossy objects, the nature of the specular reflection is dependent on local curvature of the object, such that the specular reflection from a mainly flat area on the object differs from the specular reflection from a locally concave or locally convex area.

### SUMMARY

For these and other reasons, conventional techniques for surface recovery or surface shape recovery of diffuse objects, such as projection of images of structured light onto the surface of the object, do not work well with specular objects or mirror-like objects, or other similar objects with a glossy or highly glossy surface.

The foregoing is addressed by the disclosure herein, which in one aspect provides for shape reconstruction in which a scene is illuminated with an ordered spectrum of spatially distributed light whose wavelength varies in accordance with angle, and a spectral image is captured of an object illuminated in the scene, wherein the captured spectral image includes a specular component which includes spectral data for light reflected from a point on the surface of the object. Local curvature at the point on the object is estimated based at least in part on width of the spectral data for the point at a peak in the spectral data.

For example, local curvature at the point on the object may be estimated as convex for spectral data with relatively wider width at the peak in the spectral data, and concave for a spectral data with relatively narrower width at the peak in the spectral data.

The captured spectral image may be used to estimate local curvature at multiple points on the object based at least in part on width of the spectral data for each of said multiple points at a peak in the spectral data for each of said multiple points.

By virtue of the foregoing, in which an object is illuminated with an ordered spectrum of spatially distributed light, different points on the object having different local curvatures will reflect spectra having differing spectral widths. Thus, local curvature at a point or multiple points on the object can ordinarily be estimated based at least in part on width of the captured spectrum for the point at a peak in the captured spectrum, and can ordinarily be estimated with a single image capture, or at most only a few.

The captured spectral image may include an array of pixel data in which data for each pixel includes spectral measurement data at intervals across the wavelength variation of the ordered spectrum of illumination. For example, for each pixel in the array, the interval may be five (5) nanometers or less, such as one (1) nanometer.

Calibration may be provided for calibration of the configuration by which the object in the scene is illuminated and by which the spectral image is captured. According to this aspect, local estimation of curvature may include evaluation of a ratio between width of the captured spectrum for the point at the peak and width at a peak of a captured spectrum for a calibration target having known curvature, wherein local curvature at the point on the object is estimated based on the ratio. For example, the calibration target may be relatively flat, and local curvature may be estimated as convex for a ratio greater than 1, concave for a ratio less than 1, and flat for a ratio approximately equal to 1. The calibration target may also be convex and local curvature may be estimated as similarly convex for a ratio approximately equal to 1, more convex for a ratio greater than 1, and less convex (perhaps even flat or concave) for a ratio less than 1. Likewise, the calibration target may be concave and local curvature may be estimated as similarly concave for a ratio approximately equal to 1, more concave for a ratio less than 1, and less concave (perhaps even flat or convex) for a ratio greater than 1.

The object may be repositioned, such as rotational movement, so as to expose additional regions on the surface of the object, and so as to permit estimation of local curvature and reconstruction of surface shape for such additional regions. According to this aspect, a second spectral image of the illuminated object is captured, the second spectral image including a specular component which includes second spectral data for light reflected from a second point on the surface of the object, after a repositioning which causes the second spectral image to differ from the first spectral image. Local curvature at the second point on the object is estimated based at least in part on width of the second spectral data for the second point at a peak in the second spectral data. Repeated repositionings may be performed, together with repeated capturing and estimating, so as to obtain an estimate of local curvature over roughly an entirety of the surface of the object.

In addition to estimation of local curvature, information on the surface shape of the object may also be recovered. According to one embodiment by which surface shape information is recovered, there is a set relationship by which wavelength of the ordered spectrum of spatially distributed light varies in accordance with angle. Surface shape information of the point on the surface of the object is recovered by calculations which use the captured spectrum for the point and the set relationship between wavelength and angle. For example, the recovered surface shape information may comprise a determination of a wavelength at a peak of the captured spectrum, and a mapping of the peak wavelength to an angle using the set relationship between wavelength and angle.

The set relationship between wavelength and angle may be obtained by calibration which determines correspondence between each wavelength of light and its incident angle on the scene. The correspondence may be determined by using a combination of at least two screens, and/or the correspondence may be determined by using a combination of a screen and a slit.

According to another embodiment by which surface shape information is recovered, the spectral image is captured by one or more spectral cameras, and surface shape information is recovered by triangulation of the mapped angle and a viewing direction from the one or more spectral cameras.

According to embodiments herein, surface shape information may include surface normal at the point, and/or may include depth at the point.

Especially in embodiments in which both of local curvature and surface shape information are recovered, the object may be replicated. Replication may be a physical replication such as by using a 3D printer, or replication may be a graphical replication of the object, from arbitrary perspectives and from arbitrary illumination directions and sources.

Embodiments herein describe multiple arrangements for illumination by an ordered spectrum of spatially distributed light whose wavelength varies in accordance with angle. According to one embodiment, illumination comprises projection of a collimated light source into a diffraction grating which splits the beam into the spatially distributed light whose wavelength varies in accordance with angle. The diffraction grating may be reflective or it may be transmissive. According to another embodiment, illumination comprises projection of a collimated light source into a prism which splits the beam into the spatially distributed light whose wavelength varies in accordance with angle. A set relationship between wavelength and angle may be established by calibration which determines correspondence between each wavelength of light and its incident angle on the scene.

This brief summary has been provided so that the nature of this disclosure may be understood quickly. A more complete understanding can be obtained by reference to the following detailed description and to the attached drawings.

### BRIEF DESCRIPTION OF THE DRAWINGS

FIG. 1 shows one example embodiment of a system for recovery of local curvature and surface shape of objects having a specular component of reflection.

FIG. 2 illustrates a principle of triangulation by which surface information such as depth and normal can be obtained for the surface of an object.

FIG. 3 is a view for explaining an architecture for reconstruction of local curvature and surface shape of an object.

FIGS. 4A and 4B are views for explaining one example of calibration for obtaining the relationship between wavelength and angle.

FIG. 5 is a view for explaining a further example of calibration for obtaining the relationship between wavelength and angle.

FIGS. 6A through 6C are views for explaining shape reconstruction of the surface of an object.

FIGS. 7A through 7C are views for explaining reconstruction of local curvature of the surface of an object.

FIG. 8 is a flow diagram depicting steps for shape reconstruction according to one embodiment.

FIGS. 9A through 9C are views showing examples of determining width of spectral data at a wavelength peak in the spectral data.

### DETAILED DESCRIPTION

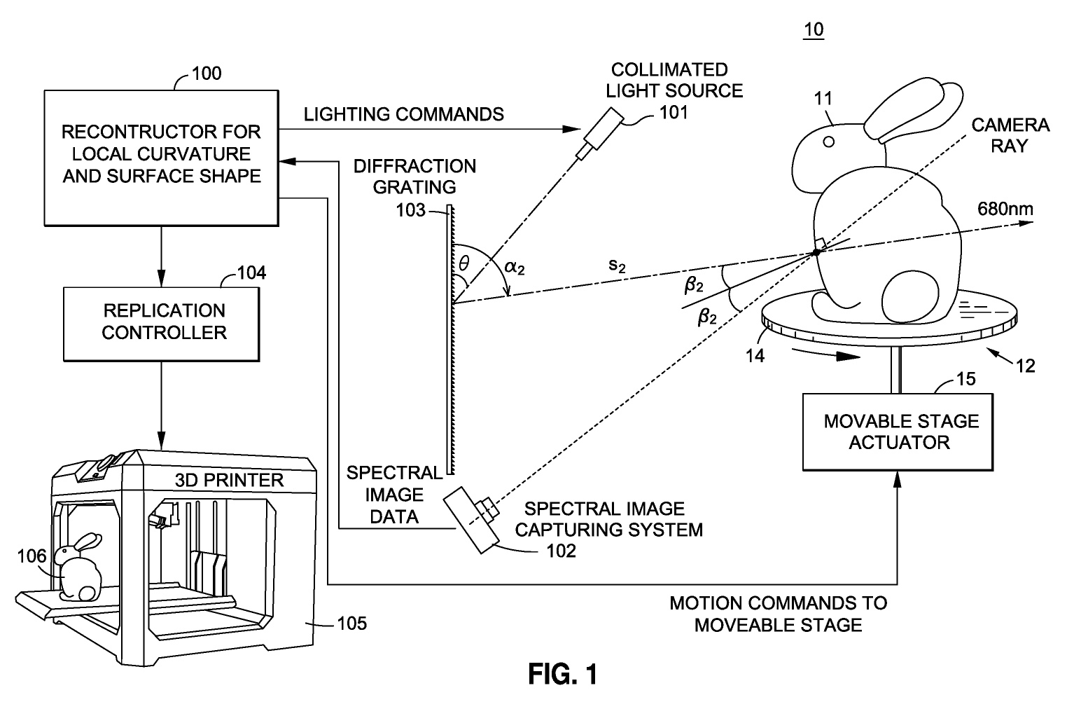

FIG. 1 is a view showing one example embodiment of a system for recovery of local curvature and surface shape of glossy objects such as mirror-like and specular objects, or objects having a specular component of reflection, in the form of a replication system 10 in which local curvature and surface shape of objects are recovered for replication, for example, for 3D replication of the object physically (such as with a 3D printer) or representationally (as with a graphics display).

While FIG. 1 depicts a replication environment, it should be understood that this is simply an example environment in which the disclosure may be practiced, and that other environments or embodiments are of course possible. For example, recovery of local curvature and surface shape can also be used in the context of automated inspection, robotics, machine vision, quality control, image retrieval, shape modelling and scene reconstruction, security and so forth, among many others.

As shown in FIG. 1, an object 11 is positioned at an inspection station 12, which in this embodiment is the surface of a movable stage 14 by which the object can be moved into varying perspectives. In this embodiment, the movable stage is movable by rotation about a vertical axis, and in other embodiments the movable stage may be a 3-axis positioning table. Object 11 is typically a specular object or a mirror-like object, or other similar object with a glossy or highly glossy surface. Movable stage 14 is moved under control of actuator 15, via motion commands issued by reconstructor 100 for reconstruction of local curvature and surface shape.

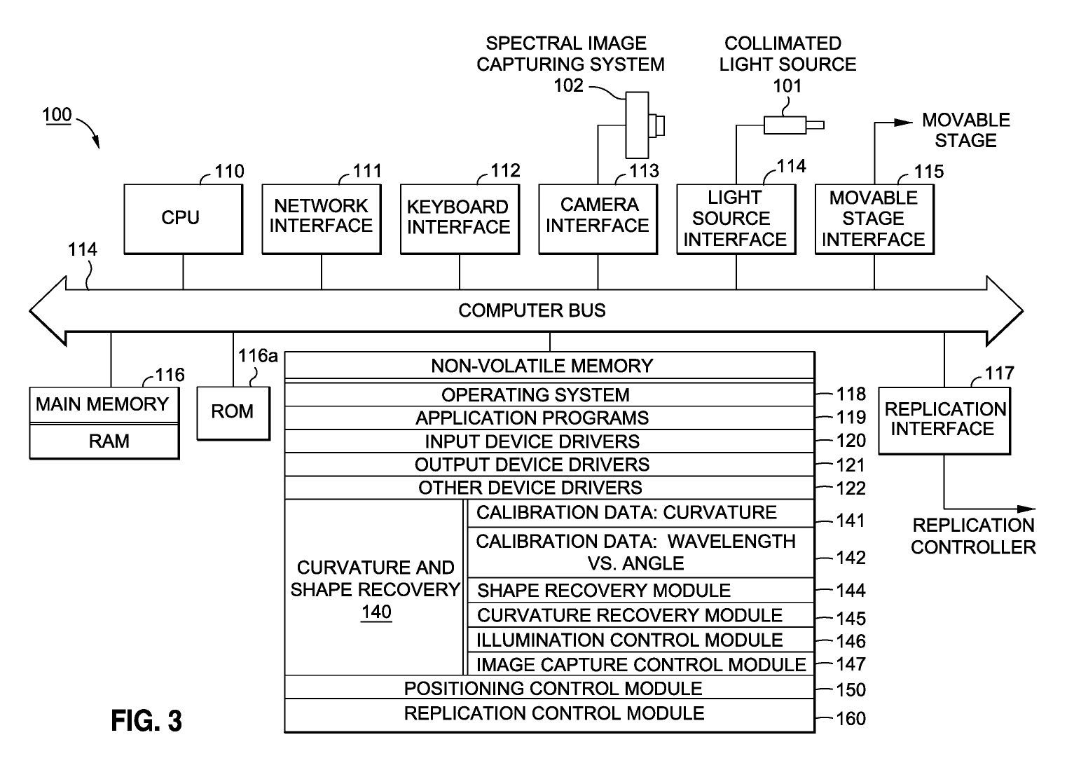

Reconstructor 100 is configured to reconstruct local curvature and surface shape of objects at inspection station 12, based on commands issued to collimated light source 101 and commands issued to actuator 15 for movable stage 14, and based on spectral image data received from spectral image capture system 102. Based on its reconstruction, reconstructor 100 controls replication controller 104 so as to obtain a 3D replication of the object. In this embodiment, 3D replication of the object is obtained physically via 3D printer 105, to produce replicated object 106. In other embodiments, 3D replication of the object may be obtained representationally via a graphics display. More details of reconstructor 100 are provided below, such as in connection with FIG. 3.

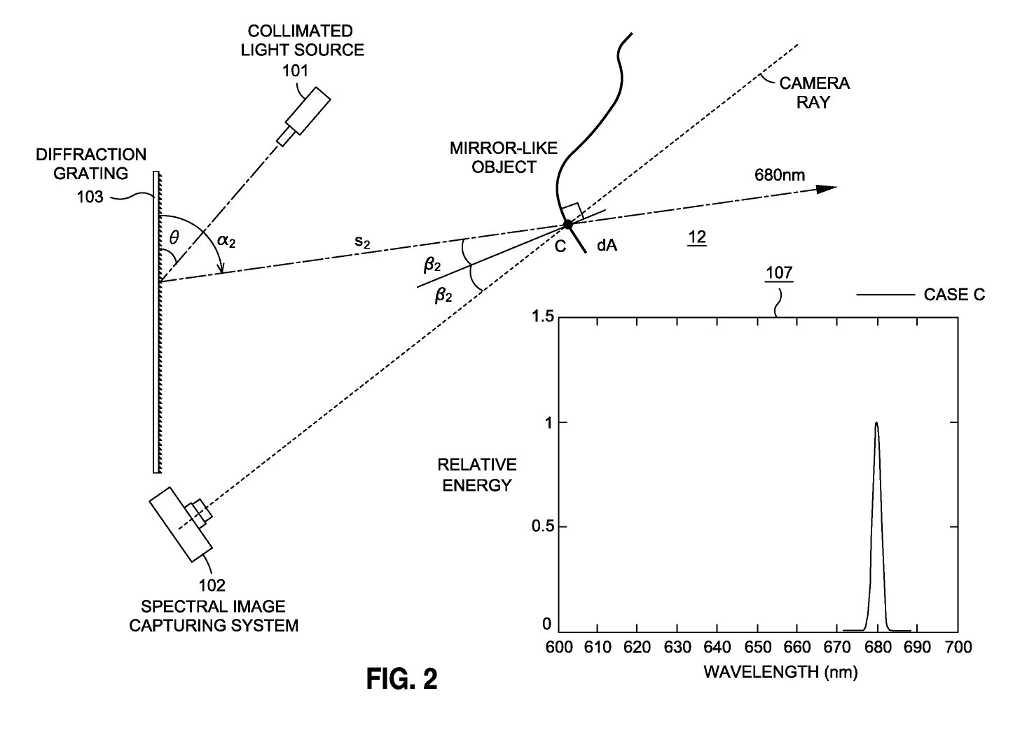

Also shown in FIG. 1 is diffraction grating 103, by which light from collimated light source 101 is diffracted into a spectrum of wavelengths whose angular relationship against objects at inspection station 12 is predetermined through calibration. More details on the relative positioning of diffraction grating 103, relative to other elements such as collimated light source 101 and spectral image capture system 102 are provided below, such as in connection with FIG. 2. More details on calibration are provided below.

FIG. 2 is a view for explaining the relative positioning of collimated light source 101, spectral image capture system 102 and diffraction grating 103, relative to an object at inspection station 12. Under control of reconstructor 100, collimated light source 101 generates a beam of white light. The light is projected onto a diffraction grating device, which may be transmissive or reflective, at some inclined angle such as θ. The beam of light is split into a continuous ordered spectrum of light with different wavelengths depending on the incident angle of θ. For a fixed angle of θ each ray leaves the diffraction grating plane at a specific angle depending on its wavelength. For example in FIG. 2, the ray s2 with a wavelength of 680 nm leaves diffraction grating at an angle of α2. This angle may hereinafter be referred to as the “departing angles” in this document. The correspondence relationship between wavelengths and departing angles are established in a calibration process, described below.

A ray of diffracted light, for example s2, is reflected off the mirror-like target at a specific angle, β2, relative to target surface normal and captured by spectral image capture system 102.

Spectral image capture system 102 captures an array of pixel data in which data for each pixel includes spectral measurement data at intervals across the wavelength variation of the ordered spectrum of illumination. Preferably, the intervals are 5 nanometers or less for each pixel in the array, and the wavelength variation is in the range of around 400 nm to 700 nm, thereby to allow for identification of a peak in the spectrum captured by each pixel, and to allow for a determination of the width of the peak in the spectrum captured by each pixel.

More specifically, the peak wavelength of a captured ray determines its corresponding departing angle at the diffraction grating plane. Using a ray of r2 determined by spectral image capture system 102 and the ray of s2 by knowing the wavelength, the intersection can be determined by triangulation. In this way the reflection angle of β2 and consequently the corresponding surface normal of the object at the inspection station can be calculated based on traditional triangulation methodology.

This is illustrated at the spectrum inset 107 of FIG. 2. As seen from this spectrum inset, one particular pixel in the array of pixels in captured image data has a spectrum which extends from around 600 nm to around 700 nm, in intervals of better than 5 nm (here, in 1 nm intervals). A peak in the spectrum for this pixel can be identified at 680 nm. This wavelength of 680 nm identifies the captured ray as ray s2, which through calibration is known to leave diffraction grating 103 at an angle of α2. The intersection of camera ray r2 and s2 determines the position as well as the surface normal at that point on the object, thereby enabling reconstruction of surface shape.

FIG. 3 is a view for explaining one embodiment of the architecture of reconstructor 100 for reconstruction of local curvature and surface shape of objects at inspection station 12.

As shown in FIG. 3, reconstructor 100 includes central processing unit (CPU) 110 which interfaces with computer bus 114. Also interfacing with computer bus 114 are network interface 111, keyboard interface 112, camera interface 113, random access memory (RAM) 116 for use as a main run-time transient memory, read only memory (ROM) 116a, replication interface 117 for interface to replication controller 104, and non-volatile memory 160 (e.g., a hard disk or other nonvolatile and non-transitory storage medium).

RAM 116 interfaces with computer bus 114 so as to provide information stored in RAM 116 to CPU 110 during execution of the instructions in software programs, such as an operating system, application programs, image processing modules, and device drivers. More specifically, CPU 110 first loads computer-executable process steps from non-volatile memory 160 or another storage device into a region of RAM 116. CPU 110 can then execute the stored process steps from RAM 116 in order to execute the loaded computer-executable process steps. Data, also, can be stored in RAM 116 so that the data can be accessed by CPU 110 during the execution of the computer-executable software programs, to the extent that such software programs have a need to access and/or modify the data.

As also shown in FIG. 3, non-volatile memory 160 contains computer-executable process steps for operating system 118, and application programs 119, such as graphic image management programs. Non-volatile memory 160 also contains computer-executable process steps for device drivers for software interface to devices, such as input device drivers 120, output device drivers 121, and other device drivers 122.

Non-volatile memory 160 also stores a curvature and shape recovery module 140, a positioning control module 150, and replication control module 160. These modules, i.e., the curvature and shape recovery module 140, the positioning control module 150, and the replication control module 160, are comprised of computer-executable process steps for recovery of reconstruction of local curvature and surface shape of an object, for repositioning of the object on movable stage 14, and for control of replication controller 104 for 3D replication of the object.

As shown in FIG. 3, curvature and shape recovery module 140 generally comprises calibration data 141 for determining local curvature of the object based on the spectral component of reflection, calibration data 142 for determining angle of a reflected ray based on its wavelength, and recovery modules 144 for recovery of surface shape and 145 for recovery of local curvature.

Curvature and shape recovery module 140 also generally comprises an illumination control module 146 for control of illumination by collimated light source 101, and image capture control module 147 for control of image capture by spectral image capturing system 102.

Positioning control module 150 controls repositioning of the object on movable stage 14, and replication control module 160 controls replication controller 104 for 3D replication of the object.

The computer-executable process steps for these modules may be configured as part of operating system 118, as part of an output device driver in output device drivers 121, or as a stand-alone application program(s). These modules may also be configured as a plug-in or dynamic link library (DLL) to the operating system, device driver or application program. It can be appreciated that the present disclosure is not limited to these embodiments and that the disclosed modules may be used in other environments.

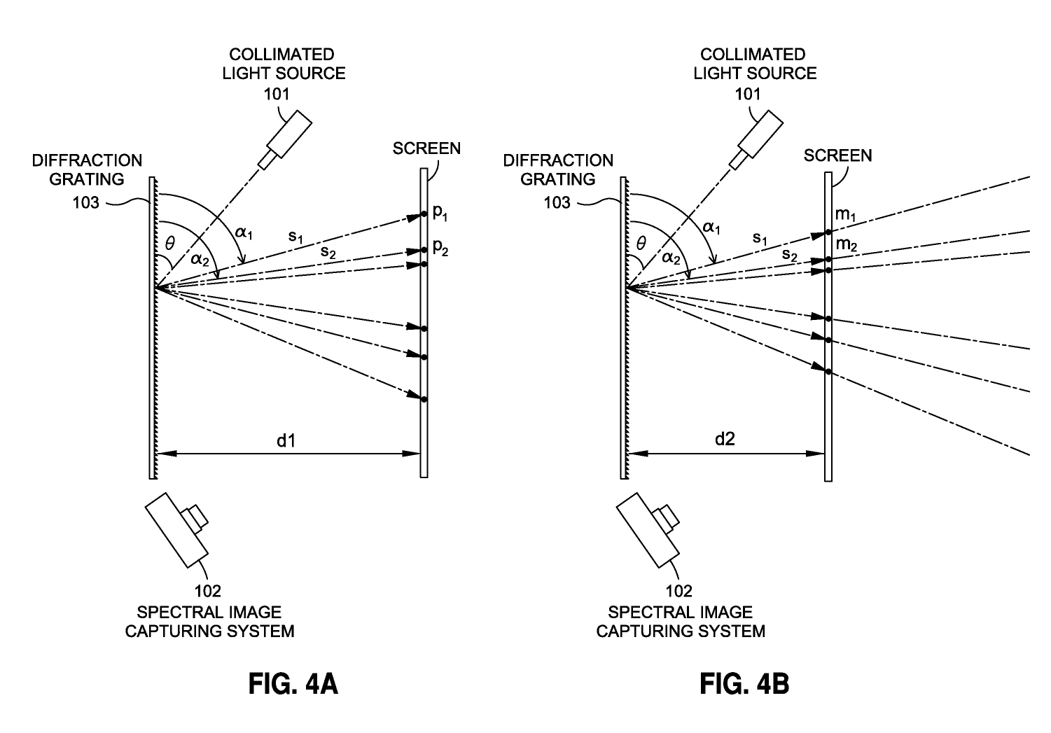

FIGS. 4A and 4B are views for explaining one example of calibration whereby the relationship between wavelength and angle is obtained, i.e., the relationship by which wavelength of the ordered spectrum of spatially distributed light varies in accordance with angle.

As shown in FIGS. 4A and 4B, for a given incident light at an angle of θ a continuous spectrum of light leaves diffraction grating 103. A diffuse screen 105 is positioned at a known distance, d1, relative to the plane of diffraction grating 103. Rays incident on the screen are imaged using a spectral imaging system 102. Incident positions, p1, p2 . . . pn, are stored. The screen is moved to another distance, d2, and another spectral image is captured. The corresponding incident positions, m1, m2 . . . mn are stored. The line connecting p1 and m1 is used to calculate the corresponding departing angle, α1. The same is performed for all wavelengths to calculate corresponding α1 . . . αn angles.

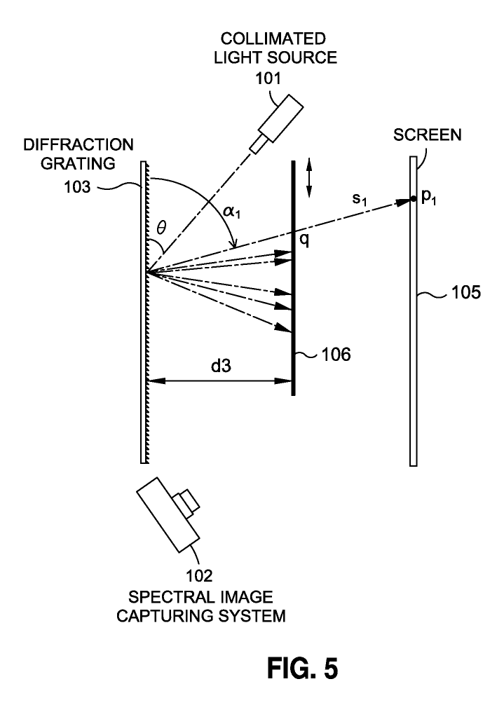

FIG. 5 is a view for explaining another example of calibration whereby the relationship between wavelength and angle is obtained. As shown in FIG. 5, a combination of a screen 105 and a slit 106 is used to calculate departing angles α1 . . . αn. The slit moves vertically to pass only a specific wavelength.

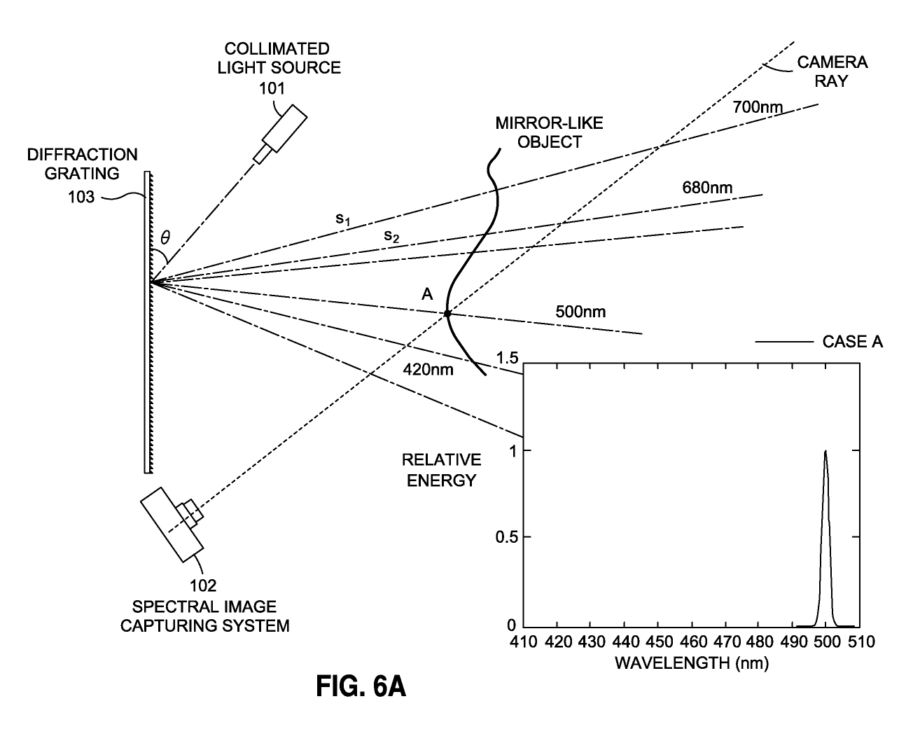

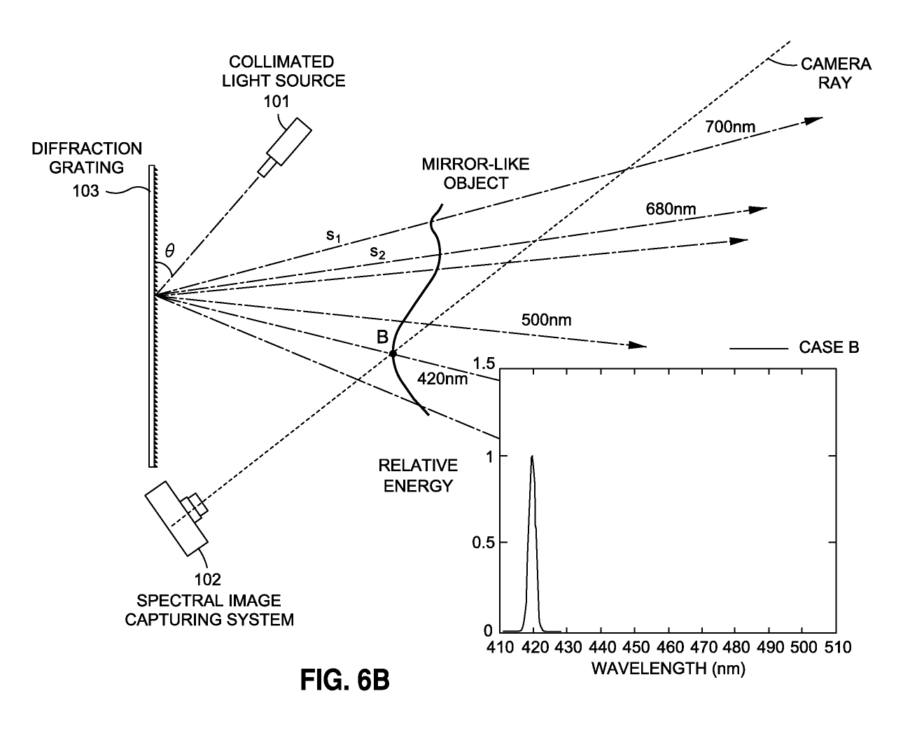

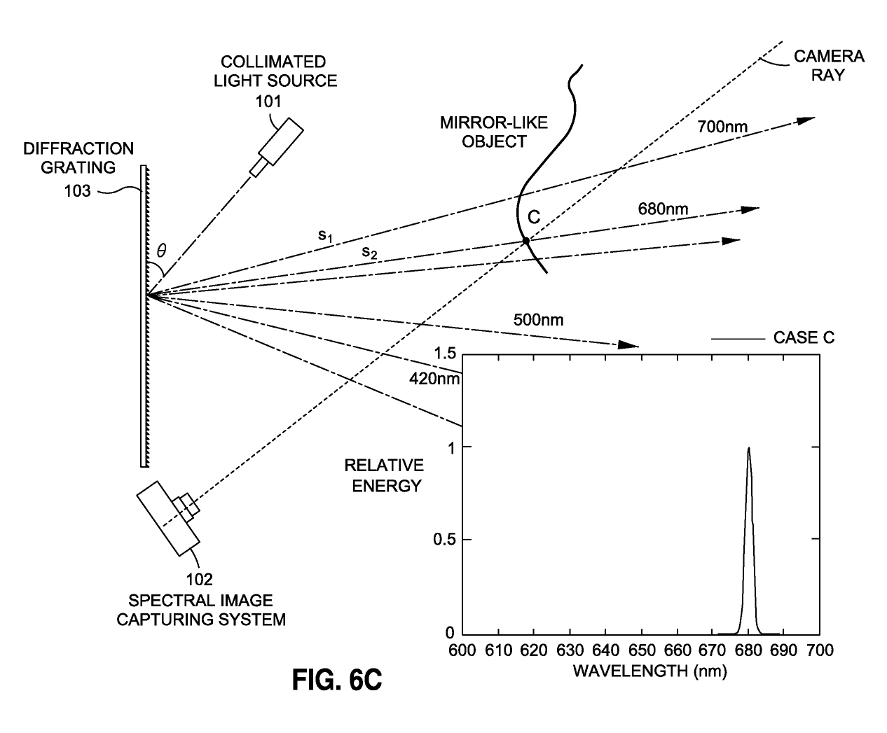

FIGS. 6A through 6C are views for explaining shape reconstruction of the surface of an object at inspection station 12. In general, according to these figures, for a given pixel in the images captured from spectral imaging system 102, a camera ray is formed. The corresponding target point on the surface of the object is located on the line defined by this ray, and the exact position of the surface is determined based on the wavelength at the peak in the captured spectrum, and based on the calibrated relationship between wavelength and angle.

Three cases are presented in FIGS. 6A through 6C. In each figure, the peak wavelength of the captured spectrum for a pixel determines the corresponding ray departing the diffraction grating 103. The intersection of the camera ray and the departing monochromatic ray is calculated using traditional triangulation methods. This determines the location of the target point as well as the surface normal at that point.

For example, in FIG. 6A, a pixel in the captured image corresponds to point A on the surface of the object. The spectrum for this pixel shows a spectral peak at 500 nm. Through calibration, the relationship between the 500 nm wavelength and the angle α from diffraction grating 103 is determined. The surface point A lies on the intersection of the camera ray and this angle, and establishes both depth of the surface of the object at point A, and surface normal at point A.

Likewise, FIG. 6B shows an example for a target point located at point B on the surface of the object corresponding to a spectral wavelength of 420 nm; and FIG. 6C shows an example for target point located at point C on the surface of the object corresponding to a spectral wavelength of 680 nm.

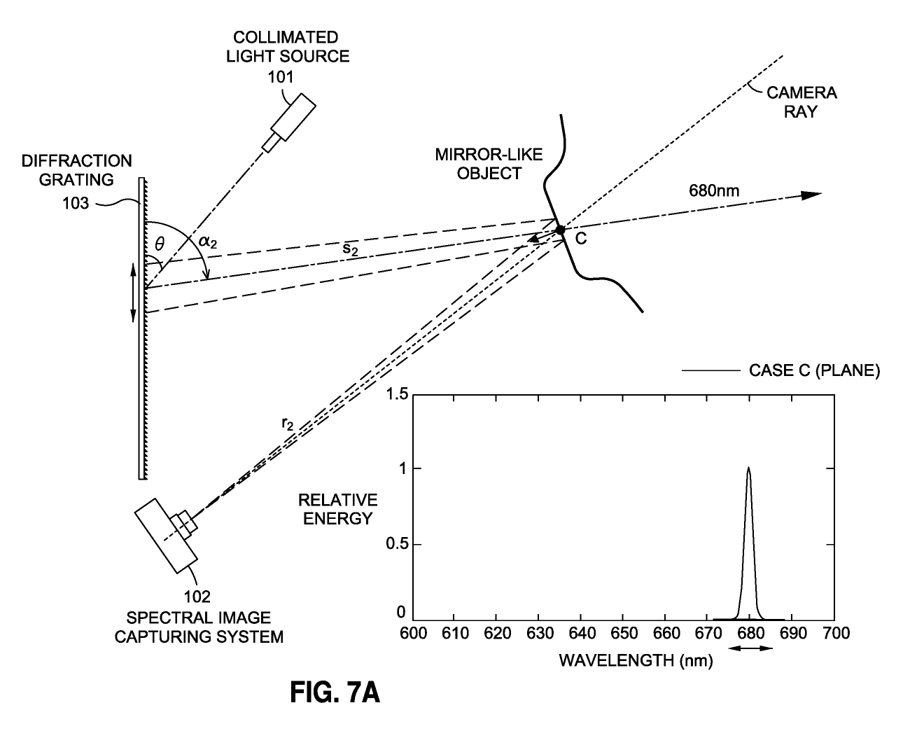

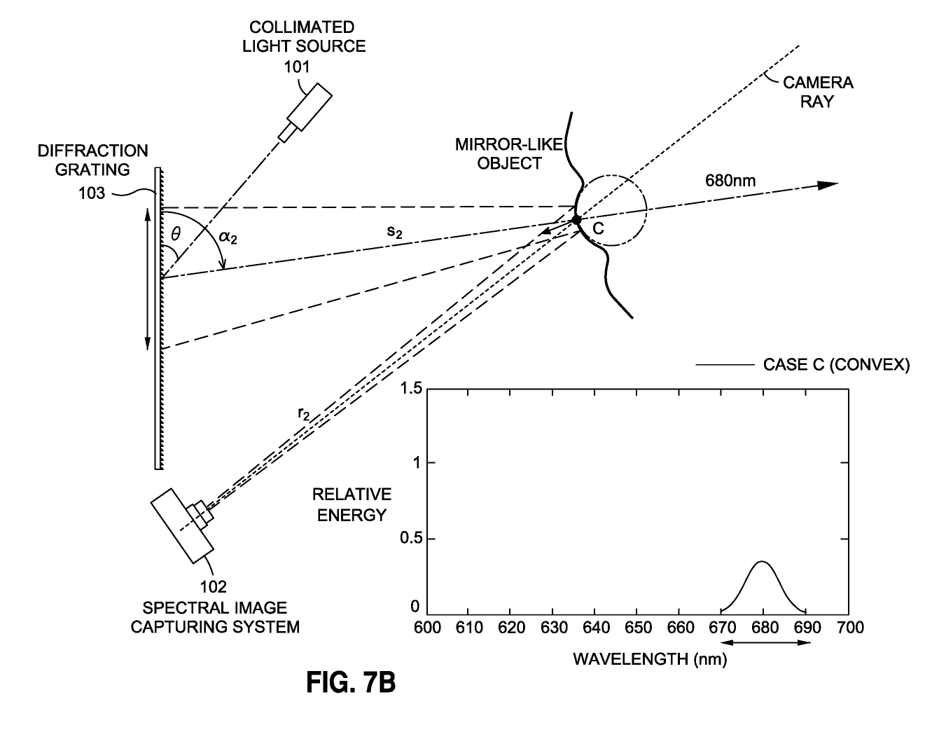

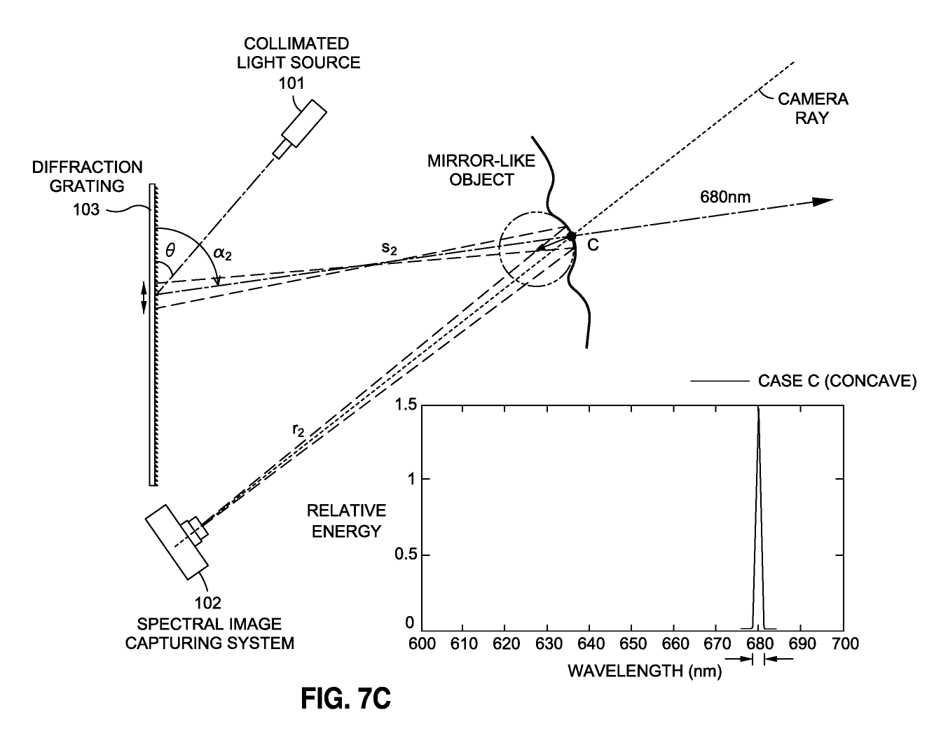

FIGS. 7A through 7C are views for explaining reconstruction of local curvature of the surface of an object at inspection station 12. In general, according to these figures, a camera pixel records all the contributions within a cone of wavelengths departing from diffraction grating 103. In FIGS. 7A through 7C, these cones are delimited by dashed lines surrounding a main, central wavelength. The dimension of the cone is affected by the physical pixel size and the camera lens parameters.

The amount of wavelengths included within the cone, hence recorded in the same pixel of the spectral imaging system, depends on the local curvature of the object. The curvature of an object point can be estimated by measuring the width of the captured spectrum.

To make this estimate of local curvature, it is helpful to obtain a baseline calibration of spectrum width for a baseline object of known curvature. In one example, the calibration target may be flat. For this example of calibration, the width of the spectrum is measured when the calibration target is a substantially flat plane, and this width is designated as Wp.

Thereafter, the measured width Wo of the spectrum for each pixel is compared against the calibrated width Wp of a flat calibration target, so as to estimate local curvature:
if Wo/Wp≈1, the object is locally flat (example in FIG. 7A);
if Wo/Wp>1, the object is locally convex (example in FIG. 7B);
if Wo/Wp<1, the object is locally concave (example in FIG. 7C).

A curvature of a point P is usually described as 1/k, where k is the radius of the circular arc which best approximates the curve at point P. For a convex curve k>0, while for a concave curve k<0. A plane has no curvature and can be represented by k=∞. FIG. 7B and FIG. 7C show the circle approximating the local curve. The ratio Wo/Wp at the object point P is proportional to k.

It will be understood from these figures that the wavelength of the peak value of the spectrum remains the same for all the three cases illustrated in FIGS. 7A through 7C. This peak value is the value used in triangulation, so as to determine depth and surface normal, leading to the observation that the 3D position of point C in all three cases is the same but its local curvature is different.

In another example of a baseline calibration of spectrum width for a baseline object of known curvature, the calibration target may be convex. For this example of calibration, the width of the spectrum is measured when the calibration object is convex, and this width is designated as Wx. Thereafter, the measured width Wo of the spectrum for each pixel is compared against the calibrated width Wx of a convex calibration target, so as to estimate local curvature:
if Wo/Wx≈1, the object is locally as convex as the calibration target;
if Wo/Wx>1, the object is locally more convex than the calibration target;
if Wo/Wx<1, the object is locally less convex than the calibration target which may in fact indicate that the object is locally flat or concave.

In another example of a baseline calibration of spectrum width for a baseline object of known curvature, the calibration target may be concave. For this example of calibration, the width of the spectrum is measured when the calibration object is concave, and this width is designated as Wv. Thereafter, the measured width Wo of the spectrum for each pixel is compared against the calibrated width Wv of a convex calibration target, so as to estimate local curvature:
if Wo/Wv≈1, the object is locally as concave as the calibration target;
if Wo/Wv<1, the object is locally more concave than the calibration target;
if Wo/Wv>1, the object is locally less concave than the calibration target which may in fact indicate that the object is locally flat or convex.

It should be understood that the measured width Wo of the spectrum of the object may be compared against one or more than one types of calibration targets so as to obtain increasingly accurate estimates of local curvature. For example, the measured width Wo of the spectrum of the object may be compared against all three types of calibration targets. In addition, the measured width Wo of the spectrum of the object may be compared against calibration targets of varying degrees of concavity or convexity, which permits increasingly refined estimates of local curvature of the object.

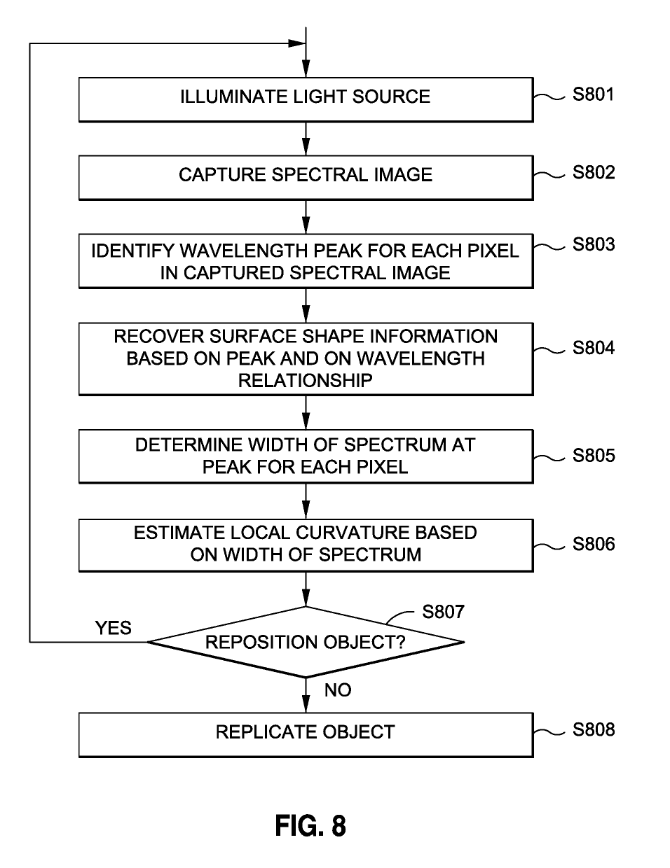

FIG. 8 is a flow diagram depicting steps for shape reconstruction according to one embodiment. The steps of FIG. 8 are preferably executed post-calibration of the relationship between wavelength and angle, and post-calibration of the spectrum width for one or more than one calibration targets. Briefly, according to the steps depicted in FIG. 8, a scene is illuminated with an ordered spectrum of spatially distributed light whose wavelength varies in accordance with angle, a spectral image of an object illuminated in the scene is captured, wherein the spectral image includes a specular component which includes spectral data for light reflected from a point on the surface of the object, and local curvature is estimated at the point on the object based at least in part on width of the spectral data for the point at a wavelength peak in the spectral data. In addition, surface shape information of the point on the surface of the object may be recovered by calculations which use the captured spectrum for the point and a calibrated relationship between wavelength and angle. The object may be repositioned, thereby to expose other areas of its surface to spectral capture, and thereby permitting shape reconstruction of as much of the entirety of the object as desired.

In more detail, in step S801, via illumination module 146, reconstructor 100 issues a lighting command to illuminate collimated light source 101. Diffraction grating 103 diffracts the light into a diffracted wavelength spread which illuminates an object 11 at inspection station 12 with an ordered spectrum of illumination. In step S802, via capture module 147, reconstructor 100 issues a capture command to spectral image capture system 102, and obtains spectral image data therefrom. As explained above, the spectral image data is an array of pixel data in which data for each pixel includes spectral measurement data at intervals across the wavelength variation of the ordered spectrum of illumination. In this embodiment, the interval is 1 nm or better.

In step S803, via shape recovery module 144, reconstructor 100 identifies the wavelength of the peak in the spectrum, for each pixel of interest in the captured spectral image. A peak may be identified for all pixels in the image, but more commonly, the peak is identified only for those pixels corresponding to an image on the surface of the object. Step S804 then recovers surface shape information by using the calibrated relationship between wavelength and angle and the peak wavelength, and then triangulation, as described above in connection with FIGS. 6A through 6C. Shape information may include depth and/or surface normal.

In step S805, via curvature recovery module 145, reconstructor 100 determines the width of the spectrum at the wavelength of the peak in the spectrum. The wavelength of the peak in the spectrum was identified in step S803, and step S805 determines the width at this wavelength for each pixel of interest. As before, a width may be determined for all pixels in the image, but more commonly, the width is determined only for those pixels corresponding to an image on the surface of the object.

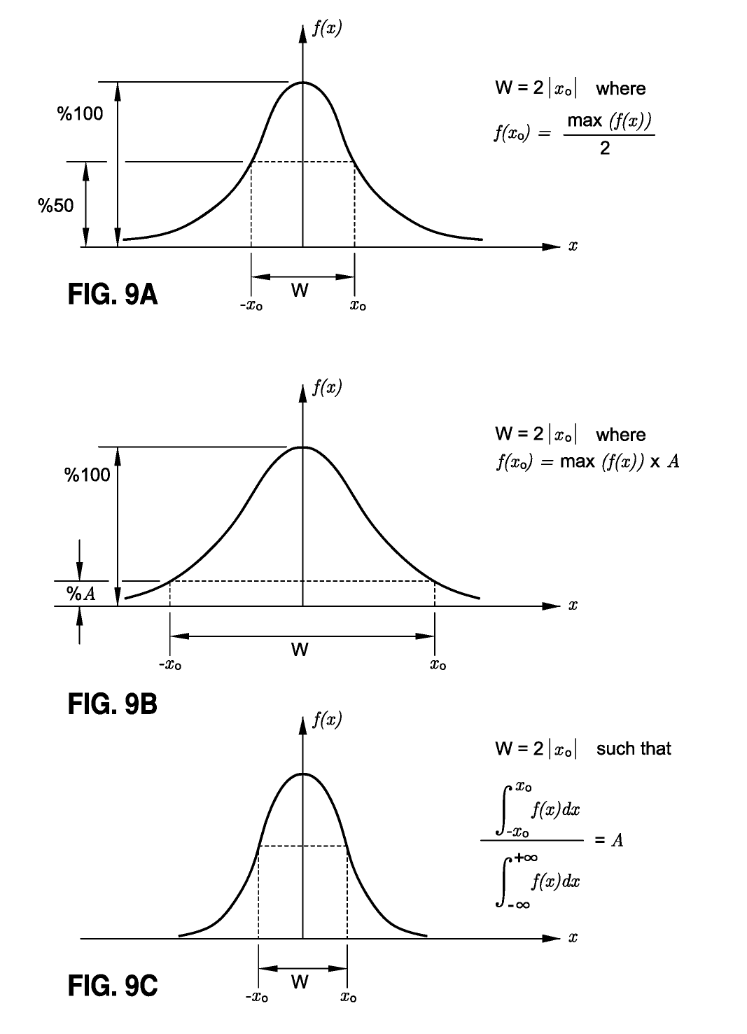

FIGS. 9A through 9C are views showing examples of determining width of spectral data for a point at a wavelength peak in the spectral data. The example of determining width shown in FIG. 9A is referred to herein as “full width at half maximum (FWHM)”. According to this example, width W of spectral data for a wavelength point at a peak in the spectral data is determined in accordance with width at 50% of the height of the spectral wavelength peak. Specifically, given a measurement f(x) of spectral data in the vicinity of a peak wavelength point, the width W at the peak wavelength may be determined as:

W=2×|x₀|

where f(x₀)=max(f(x))/2

The example of determining width shown in FIG. 9B is referred to herein as “width at scaled maximum (WSM)”. According to this example, width W of spectral data for a wavelength point at a peak in the spectral data is determined in accordance with width at a scale factor A of the height of the spectral wavelength peak. Specifically, given a measurement f(x) of spectral data in the vicinity of a peak wavelength point, the width W at the peak wavelength may be determined as:

W=2×|x₀|

where f(x₀)=A×max(f(x))

The example of determining width shown in FIG. 9C is referred to herein as “fixed percentile width (FPW)”. According to this example, width W of spectral data for a wavelength point at a peak in the spectral data is determined in accordance with width at a scale factor A of the total area enclosed by spectral data in the vicinity of the spectral wavelength peak. Specifically, given a measurement f(x) of spectral data in the vicinity of a peak wavelength point, the width W at the peak wavelength may be determined as:

W=2×|x₀|

where A=∫₋ₓ_{₀}^{+x}^{₀}f(x)dx/∫_{-∞}^{+∞}f(x)dx

Here, in this FPW example of determining width, it will be understood that although the limits in the integral for the denominator are shown as ±∞, the actual limits refer to the vicinity of the peak wavelength point.

Reverting to FIG. 8, step S806 then estimates local curvature using the width of the spectrum and the calibrated width of one or more than one calibration targets, such as one or more than one of a flat calibration target, a concave calibration target, and a convex calibration target. The ratios as described above in connection with FIGS. 7A through 7C may be used.

In step S807, via positioning module 150, reconstructor 100 issues a positioning command to reposition movable stage 14 and the object thereon. Repositioning of the object exposes other areas of its surface to spectral capture, such that subsequent spectral captures differ from prior spectral captures, and thereby permits shape reconstruction of as much of the entirety of the object as desired. Flow then returns to step S801, for repeated spectral captures and shape reconstruction processing, for as much of the surface of the object as desired.

When no further repositionings are performed, flow advances to step S808, where via replication control module 160 the reconstructor 100 executes 3D replication of the object. Replication may be a physical replication such as by using 3D printer 105, or replication may be a graphical replication of the object, from arbitrary perspectives and from arbitrary illumination directions and sources.

### Computer Implementation

The example embodiments described herein may be implemented using hardware, software or a combination thereof and may be implemented in one or more computer systems or other processing systems. However, the manipulations performed by these example embodiments were often referred to in terms, such as entering, which are commonly associated with mental operations performed by a human operator. No such capability of a human operator is necessary, in any of the operations described herein. Rather, the operations may be completely implemented with machine operations. Useful machines for performing the operation of the example embodiments presented herein include general purpose digital computers or similar devices.

From a hardware standpoint, a CPU typically includes one or more components, such as one or more microprocessors, for performing the arithmetic and/or logical operations required for program execution, and storage media, such as one or more disk drives or memory cards (e.g., flash memory) for program and data storage, and a random access memory, for temporary data and program instruction storage. From a software standpoint, a CPU typically includes software resident on a storage media (e.g., a disk drive or memory card), which, when executed, directs the CPU in performing transmission and reception functions. The CPU software may run on an operating system stored on the storage media, such as, for example, UNIX or Windows (e.g., NT, XP, and Vista), Linux, and the like, and can adhere to various protocols such as the Ethernet, ATM, TCP/IP protocols and/or other connection or connectionless protocols. As is well known in the art, CPUs can run different operating systems, and can contain different types of software, each type devoted to a different function, such as handling and managing data/information from a particular source, or transforming data/information from one format into another format. It should thus be clear that the embodiments described herein are not to be construed as being limited for use with any particular type of server computer, and that any other suitable type of device for facilitating the exchange and storage of information may be employed instead.

A CPU may be a single CPU, or may include plural separate CPUs, wherein each is dedicated to a separate application, such as, for example, a data application, a voice application, and a video application. Software embodiments of the example embodiments presented herein may be provided as a computer program product, or software, that may include an article of manufacture on a machine accessible or non-transitory computer-readable medium (i.e., also referred to as “machine readable medium”) having instructions. The instructions on the machine accessible or machine readable medium may be used to program a computer system or other electronic device. The machine-readable medium may include, but is not limited to, floppy diskettes, optical disks, CD-ROMs, and magneto-optical disks or other type of media/machine-readable medium suitable for storing or transmitting electronic instructions. The techniques described herein are not limited to any particular software configuration. They may find applicability in any computing or processing environment. The terms “machine accessible medium”, “machine readable medium” and “computer-readable medium” used herein shall include any non-transitory medium that is capable of storing, encoding, or transmitting a sequence of instructions for execution by the machine (e.g., a CPU or other type of processing device) and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

While various example embodiments have been described above, it should be understood that they have been presented by way of example, and not limitation. It will be apparent to persons skilled in the relevant art(s) that various changes in form and detail can be made therein. Thus, the present invention should not be limited by any of the above described example embodiments, but should be defined only in accordance with the following claims and their equivalents.

1. A shape reconstruction method comprising:
illuminating a scene with an ordered spectrum of spatially distributed light whose wavelength varies in accordance with angle;
capturing a spectral image of an object illuminated in the scene, the spectral image including a specular component which includes spectral data for light reflected from a point on the surface of the object; and
estimating local curvature at the point on the object based at least in part on width of the spectral data for the point at a wavelength peak in the spectral data.

2. The method according to claim 1, wherein the captured spectral image comprises an array of pixel data in which data for each pixel includes spectral measurement data at intervals across the wavelength variation of the ordered spectrum of illumination.

3. The method according to claim 1, wherein the intervals are 5 nanometers or less for each pixel in the array.

4. The method according to claim 1, wherein the captured spectral image is used to estimate local curvature at multiple points on the object based at least in part on width of the spectral data for each of said multiple points at a peak in the spectral data for each of said multiple points.

5. The method according to claim 1, wherein local curvature at the point on the object is estimated as convex for spectral data with relatively wider width at the peak in the spectral data, and concave for spectral data with relatively narrower width at the peak in the spectral data.

6. The method according to claim 1, further comprising evaluation of a ratio between width of the spectral data for the point at the peak and width at a peak of spectral data for a calibration target having known curvature, wherein local curvature at the point on the object is estimated based on the ratio.

7. The method according to claim 6, wherein the calibration target is relatively flat and local curvature is estimated as convex for a ratio greater than 1, concave for a ratio less than 1, and flat for a ratio approximately equal to 1.

8. The method according to claim 6, wherein the calibration target is convex and local curvature is estimated as convex as the calibration target for a ratio approximately equal to 1, more convex than the calibration target for a ratio greater than 1, and either less convex than the calibration target or flat or concave for a ratio less than 1.

9. The method according to claim 6, wherein the calibration target is concave and local curvature is estimated as concave as the calibration target for a ratio approximately equal to 1, more concave than the calibration target for a ratio less than 1, and either less concave than the calibration target or flat or convex for a ratio greater than 1.

10. The method according to claim 1, further comprising:
capturing a second spectral image of the object, the second spectral image including a specular component which includes second spectral data for light reflected from a second point on the surface of the object, after a repositioning which causes the second spectral image to differ from the first spectral image; and
estimating local curvature at the second point on the object based at least in part on width of the second spectral data for the second point at a peak in the second spectral data.

11. The method according to claim 10, further comprising repeated repositioning and capturing and estimating, so as to obtain an estimate of local curvature over roughly an entirety of the surface of the object.

12. The method according to claim 1, wherein wavelength of the ordered spectrum of spatially distributed light varies in accordance with angle at a set relationship between wavelength and angle;
and further comprising recovering surface shape information of the point on the surface of the object by calculations which use the captured spectrum for the point and the set relationship between wavelength and angle.

13. The method according to claim 12, wherein the recovered surface shape information comprises a determination of a wavelength at a peak of the captured spectrum, and a mapping of the peak wavelength to an angle using the set relationship between wavelength and angle.

14. The method according to claim 13, wherein the spectral image is captured by one or more spectral cameras.

15. The method according to claim 14, wherein the surface shape information is recovered by triangulation of the mapped angle and a viewing direction from the one or more spectral cameras.

16. The method according to claim 12, wherein the surface shape information includes surface normal at the point.

17. The method according to claim 12, wherein the surface shape information includes depth at the point.

18. The method according to claim 12, wherein the set relationship between wavelength and angle is obtained by calibration which determines correspondence between each wavelength of light and its incident angle on the scene.

19. The method according to claim 18, wherein the correspondence is determined by using a combination of at least two screens.

20. The method according to claim 18, wherein the correspondence is determined by using a combination of a screen and a slit.

21. The method according to claim 12, further comprising replication of the object.

22. The method according to claim 21, wherein replication is physical replication of the object using a 3D printer.

23. The method according to claim 21, wherein replication is a graphical replication of the object, from arbitrary perspectives and from arbitrary illumination directions and sources.

24. The method according to claim 1, wherein illuminating the scene comprises projecting a collimated light source into a diffraction grating which splits the beam into the spatially distributed light whose wavelength varies in accordance with angle, wherein the diffraction grating includes at least one of a reflective diffraction grating and a transmissive diffraction grating.

25. The method according to claim 24, wherein a set relationship between wavelength and angle is established by calibration which determines correspondence between each wavelength of light and its incident angle on the scene.

26. An apparatus comprising:
an illumination source constructed to illuminate a scene with an ordered spectrum of spatially distributed light whose wavelength varies in accordance with angle;
an image capture device positioned to capture a spectral image of an object illuminated in the scene, the spectral image including a specular component which includes spectral data for light reflected from a point on the surface of the object; and
a processor configured to estimate local curvature at the point on the object based at least in part on width of the spectral data for the point at a wavelength peak in the spectral data.

27. An apparatus comprising:
a memory which stores computer-executable process steps; and
a processor configured to execute the computer-executable process steps stored in the memory;
wherein the computer-executable process steps stored in the memory, when executed by the processor, cause the processor to:
illuminating a scene with an ordered spectrum of spatially distributed light whose wavelength varies in accordance with angle;
capturing a spectral image of an object illuminated in the scene, the spectral image including a specular component which includes spectral data for light reflected from a point on the surface of the object; and
estimating local curvature at the point on the object based at least in part on width of the spectral data for the point at a wavelength peak in the spectral data.

28. A non-transitory storage medium on which is stored computer-executable process steps which when executed by a computer cause the computer to perform a method comprising:
illuminating a scene with an ordered spectrum of spatially distributed light whose wavelength varies in accordance with angle;
capturing a spectral image of an object illuminated in the scene, the spectral image including a specular component which includes spectral data for light reflected from a point on the surface of the object; and
estimating local curvature at the point on the object based at least in part on width of the spectral data for the point at a wavelength peak in the spectral data.
